(19) United States
(12) Patent Application Publication
(10) Pub. No.: US 2016/0125538 A1
(43) Pub. Date: May 5, 2016

(54) CREATIVE GENERATION OF FINANCIAL PORTFOLIOS

(71) Applicant: International Business Machines Corporation, Armonk, NY (US)

(72) Inventors: Debarun Bhattacharjya, New York, NY (US); Mark H. Linehan, Yorktown Heights, NY (US); Florian Pinel, New York, NY (US)

(21) Appl. No.: 14/527,808

(22) Filed: Oct. 30, 2014

(51) Int. Cl. G06Q 40/06

(52) U.S. Cl. CPC G06Q 40/06

(57) ABSTRACT

A method, computer program product, and system for generating financial portfolios, the method included categorizing, by a computer, financial assets in a database of financial portfolios into asset categories based on their characteristics, clustering, by the computer, the financial portfolios of the database into a plurality of portfolio clusters based on the asset categories, each portfolio cluster includes financial portfolios having similar asset allocations in similar asset categories, identifying, by the computer, a target portfolio cluster from the plurality of portfolio clusters based on pre-defined financial metrics, and generating, by the computer, novel combinations of assets within the boundaries of the target portfolio cluster, the novel combinations of assets have similar asset allocations in similar asset categories and similar financial metrics as the target portfolio cluster.

### BACKGROUND

The present invention relates generally to automated electrical financial management and more particularly to portfolio selection.

A financial portfolio is a set of financial assets or securities (ex: stocks, bonds, etc.). At its most basic level, it is specified by the level of the portfolio owner's investment in each asset. Financial portfolio owners typically try to optimize financial indicators based on their preferences. Key preferences include liquidity and expected financial return on investment balanced with risk over some period of time. Portfolio owners typically seek a diverse portfolio spanning different types of investments, sectors of activity and geographies, since this might hedge the risks involved. The portfolio owner may have specific requirements, for instance, they may wish to include or exclude certain types of financial assets based on their geographies or industries. Generally, the overall objective is to maximize the return on investment (ROI) over some time period, while trying to manage risk, liquidity and the afore-mentioned preferences.

### SUMMARY

Embodiments of the present invention disclose a method, computer program product, and system for generating financial portfolios, the method included categorizing, by a computer, financial assets in a database of financial portfolios into asset categories based on their characteristics, clustering, by the computer, the financial portfolios of the database into a plurality of portfolio clusters based on the asset categories, each portfolio cluster includes financial portfolios having similar asset allocations in similar asset categories, identifying, by the computer, a target portfolio cluster from the plurality of portfolio clusters based on pre-defined financial metrics, and generating, by the computer, novel combinations of assets within the boundaries of the target portfolio cluster, the novel combinations of assets have similar asset allocations in similar asset categories and similar financial metrics as the target portfolio cluster.

### BRIEF DESCRIPTION OF THE SEVERAL VIEWS OF THE DRAWINGS

FIG. 1 is a functional block diagram illustrating a system for creative generation of financial portfolios in a networked computer environment, in accordance with an exemplary embodiment.

FIG. 2 is a flowchart depicting operational steps of a portfolio generation program within the networked computer environment of FIG. 1, in accordance with an exemplary embodiment.

FIG. 3 is a featurization chart, in accordance with an exemplary embodiment.

FIG. 4 is a post-characterization chart, in accordance with an exemplary embodiment.

FIG. 5 is a flowchart depicting operational steps of identifying a target portfolio cluster as part of the portfolio generation program, in accordance with an exemplary embodiment.

FIG. 6 illustrates featurization of a sample portfolio, in accordance with an exemplary embodiment.

FIG. 7 is a functional block diagram of components of a server computer executing the portfolio generation program, in accordance with an exemplary embodiment.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Financial portfolios (hereinafter “portfolios”) and targets evolve over time, depending on investment goal and horizon, or changes in financial markets. There are many possible financial assets (hereinafter “assets”) and combinations of assets that a portfolio owner could consider. Due to the sheer quantity, a portfolio owner may therefore not have the necessary knowledge nor the capability to select assets among the many potential investments. How can a portfolio owner generate a creative set or grouping of assets combinations (that may go well together) to choose from? How can a portfolio owner find an asset combination that is aligned with their financial objectives, such as maximizing expected return, and satisfy custom constraints on investment categories, such as, risk and liquidity?

Embodiments of the present invention use a novel portfolio generation program to create financial portfolios that meet the specified user-defined requirements by using a database of existing portfolios. The portfolio generation program will recommend a novel portfolio that is creative, for example, a portfolio that might be novel while simultaneously satisfying the owners preferences and constraints regarding financial KPIs (ex: risk-adjusted reward). The value of novelty is that it may expose new and creative ways to achieve desired financial goals. In its most basic form, the portfolio generation program may first cluster similar combinations of assets from a database of existing portfolios. Next, the program identifies a portfolio category or cluster which best represents the desired investment strategy of a user. Finally, the program will generate and select a creative a new portfolio, based on the cluster.

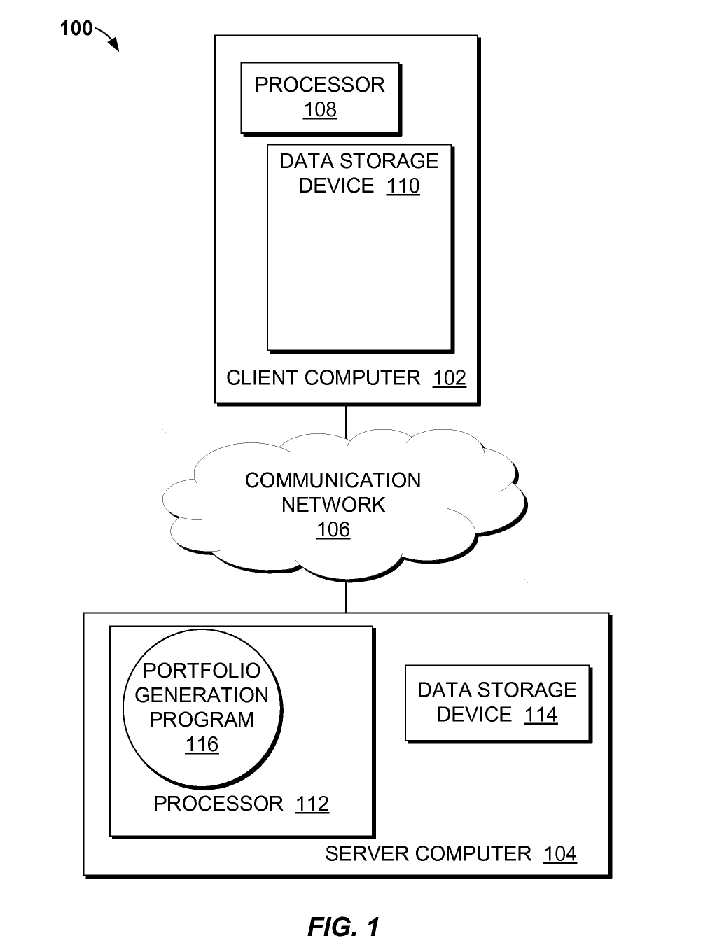

Referring now to FIG. 1, a functional block diagram illustrating a system 100 for creative generation of financial portfolios in a networked computer environment, in accordance with an embodiment of the present invention is shown. The system 100 may include a client computer 102 and a server computer 104. The client computer 102 may communicate with the server computer 104 via a communications network 106 (hereinafter “network”). The client computer 102 may include a processor 108 and a data storage device 110 that is enabled to interface with a user and communicate with the server computer 104. The server computer may also include a processor 112 and a data storage device 114 that is enabled to run a portfolio generation program 116. In an embodiment, the client computer 102 may operate as an input device including a user interface while the portfolio generation program 116 may run primarily on the server computer 104. It should be noted, however, that processing for the portfolio generation program 116 may, in some instances be shared amongst the client computer 102 and the server computer 104 in any ratio. In another embodiment, the portfolio generation program 116 may operate on more than one server computer 104, client computer 102, or some combination of server computers 104 and client computers 102, for example, a plurality of client computers 102 communicating across the network 106 with a single server computer 104.

The network 106 may include wired connections, wireless connections, fiber optic connections, or some combination thereof. In general, the network 106 can be any combination of connections and protocols that will support communications between the client computer 102 and the server computer 104. The network 106 may include various types of networks, such as, for example, a local area network (LAN), a wide area network (WAN) such as the Internet, a telecommunication network, a wireless network, a public switched network and/or a satellite network.

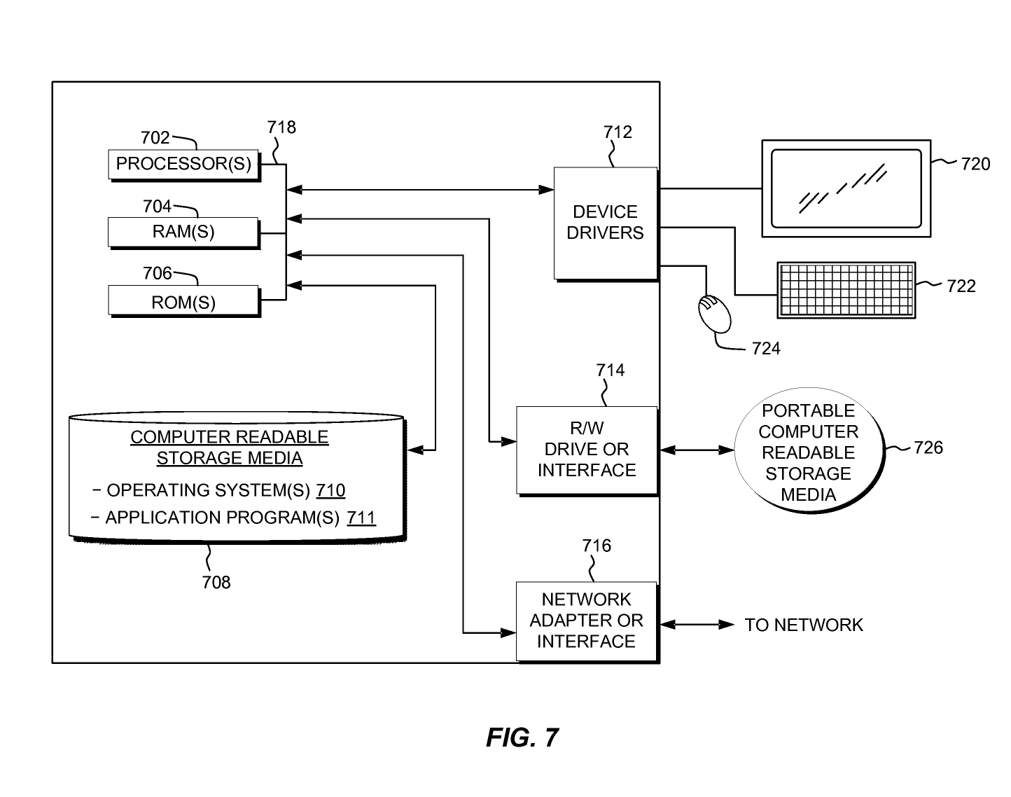

In various embodiments, the client computer 102 and/or the server computer 104 may be, for example, a laptop computer, tablet computer, netbook computer, personal computer (PC), a desktop computer, a personal digital assistant (PDA), a smart phone, a mobile device, or any programmable electronic device capable of communicating with the server computer 104 via the network 106. As described below with reference to FIG. 7, the client computer 102 and the server computer 104 may each include internal and external components.

In an embodiment, the system 100 may include any number of client computers 102 and/or server computers 104; however only one of each is shown for illustrative purposes only. It may be appreciated that FIG. 1 provides only an illustration of one implementation and does not imply any limitations with regard to the environments in which different embodiments may be implemented. Many modifications to the depicted environments may be made based on design and implementation requirements.

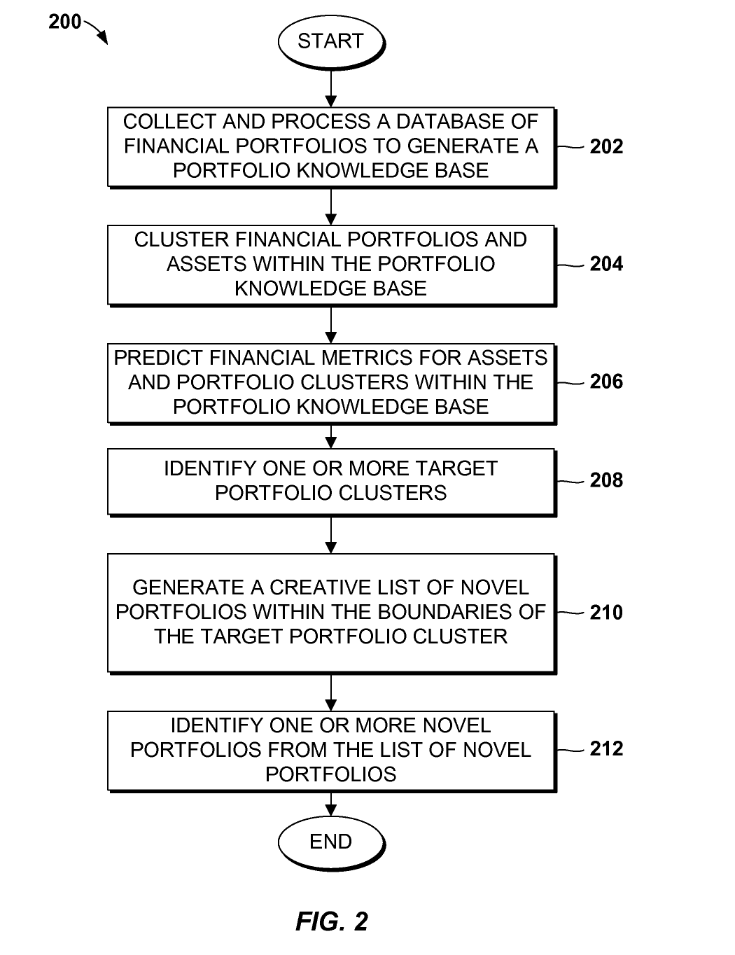

In an embodiment, the portfolio generation program 116 may run on the server computer 104. The portfolio generation program 116 may be used to generate a novel portfolio of financial assets, or novel financial portfolio, corresponding with individualized investment constraints or financial metrics. For example, a user may access the portfolio generation program 116 running on the server computer 104 via the client computer 102 and the network 106. The user may use the client computer 102 to input or provide the portfolio generation program 116 with the investment constraints, and the portfolio generation program 116 will generate and provide the user, via the client computer 102, with a novel portfolio matched to the inputted investment constraints. The portfolio generation program 116 and associated method is described and explained in further detail below with reference to FIGS. 2-6.

Referring now to FIG. 2 a flowchart 200 depicting operational steps of the portfolio generation program 116 for generating a novel portfolio of financial assets, is shown in accordance with an embodiment of the present invention. The portfolio generation program 116 may begin by collecting and processing a database of financial portfolios (step 202). In an embodiment, a portfolio database may be generated by collecting financial portfolios from one or more sources. In such cases, the portfolio database may include a compilation of financial portfolios from tens or hundreds of different sources. In another embodiment, a preexisting database of financial portfolios may be used. In all cases, the portfolio database may include an unlimited number of portfolios. Using a larger portfolio database may produce more diverse results. More specifically, using a larger portfolio database may result in a larger variety of novel portfolios and/or more creative novel portfolios. A novel or creative financial portfolio may refer to a unique and distinctive collection of financial assets. In an embodiment, for example, the portfolio database may include tens of thousands of financial portfolios compiled from tens or hundreds of different sources.

The portfolio database may then be processed to identify unique portfolios having consistent or steady asset allocation over time. The unique portfolios identified during processing of the portfolio database may then be compiled to generate a portfolio knowledge base. In an embodiment, the portfolio knowledge base may be a modified version of the portfolio database. In another embodiment, the portfolio knowledge base may be another database separate and apart from the portfolio database. During processing of the portfolio database, an individual portfolio may be split and identified as two or more unique portfolios when the asset distribution within the portfolio changes above a certain threshold, for example, 1%. By splitting the portfolios as described above, each unique portfolio may be defined by a more uniform and constant asset composition. Additionally, portfolios with a lifespan shorter than a predetermined threshold, for example 1 year, may be discarded or ignored during processing, and thus omitted from the portfolio knowledge base. The portfolio knowledge base may include all of the unique portfolios identified during processing.

For example, portfolio A of the portfolio database may be processed by the portfolio generation program 116. Portfolio A began or was created on January 2010 with an asset allocation of 50% IBM assets and 50% American Express assets. On January 2011 portfolio A's asset allocation switched to 100% IBM. Therefore, after processing, portfolio A would be classified into two unique portfolios, portfolio B and portfolio C, due to the change in the investment distribution in January 2011. Portfolio B would include an asset allocation of 50% IBM assets and 50% American Express assets, and portfolio C would include an asset allocation of 100% IBM assets.

The portfolio knowledge base may further contain characteristic information for each unique portfolio as well as for individual assets of the unique portfolios. For each unique portfolio the portfolio knowledge base may include information such as start date, end date, start value, end value, and asset composition. For individual assets the portfolio knowledge base may include information such as risk assessment, returns assessment, asset type, sector of activity, and geography.

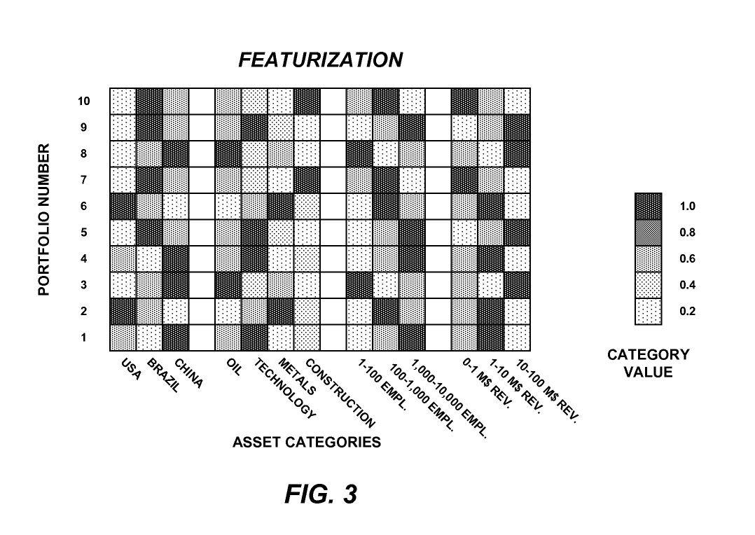

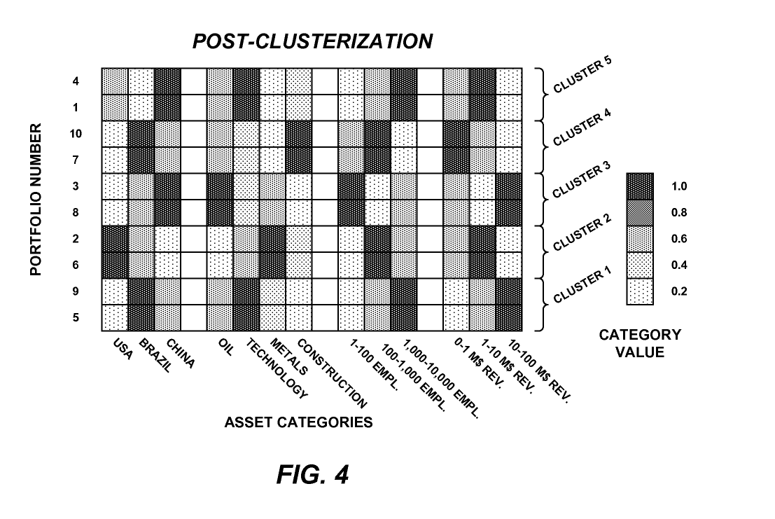

Referring now to FIGS. 3 and 4, and with continued reference to FIG. 2, the portfolio generation program 116 may cluster the unique portfolios and assets of the portfolio knowledge base (step 204). More specifically, FIG. 3 depicts a featurization chart and FIG. 4 depicts a post-clusterization chart. The charts of FIG. 3 and FIG. 4 each depict ten unique portfolios identified by number along the y-axis and a variety of asset categories identified along the x-axis. The featurization chart of FIG. 3 illustrates assigning a category value to each asset category of each of the ten portfolios. The different asset categories may alternatively be referred to as portfolio features. The post-clusterization chart of FIG. 4 illustrates organizing the unique portfolios into clusters based on the category values assigned to the asset categories they contain. More specifically, unique portfolios having similar asset category values in similar categories may be clustered together.

With specific reference to FIG. 3, first, individual assets of the unique portfolios within of the portfolio knowledge base may be classified into asset categories. The asset categories may be defined by one or more characteristic, attribute, or property of the asset. The assets of the portfolio knowledge base may, in some instances, be categorized into hundreds of different asset categories. Stated differently, hundreds of different asset categories may be defined by the variety of different assets of the portfolio knowledge base. In an embodiment, for example, the asset categories may include, for example but not limited to, geography, industry sector, company size, revenue, type of financial instrument, capital return, income production, and volatility. While hundreds of different asset categories may exist, a limited number of asset categories are depicted in the figures for illustrative and exemplary purposes only. The asset categories are not the same as asset classes, such as, for example, equities, fixed income, or equivalents, nor are they the same as asset types, such as, for example, money, stocks, and bonds. Instead the asset categories are narrower and more restrictive than asset classes or types. For example two assets may share the same asset class or type, but may be categorized into two different asset categories.

Next, category values may be assigned to each asset category of each unique portfolio. The assignment of category values may be based on the asset allocation of a particular category of assets within a unique portfolio. The asset allocation may be measured in terms of a percentage and may be used to assign a corresponding category value from a predetermined range of values. For example, a higher asset allocation percentage may correspond with a higher category value and a lower asset allocation percentage may correspond with a lower category value. In an embodiment, the category value may be equal to the percentage of a portfolio that belongs to a given asset category. In other words, the category values may be represented as a percentage. It should be noted that the ten portfolios in FIGS. 3 and 4 represent ten unique portfolios from the portfolio knowledge base generated above in step 202. Furthermore, only ten unique portfolios are depicted for illustrative purposes only, and clustering may involve any number of unique portfolios of the portfolio knowledge base, and preferably involve all of the unique portfolios identified in the portfolio knowledge base.

For example, with continued reference to FIG. 3, the category value as indicated by the key provided to the right of the featurization chart may range from 0.2 to 1; however, any know ranking scale may be used. In general, a low category value (0.2) may indicate a relatively low percentage of the unique portfolio's assets are allocated in that particular asset category. More specifically, unique portfolio number 1 of FIG. 3 is assigned a category value of 0.2 for the asset category BRAZIL, indicating unique portfolio number 1 has a relatively low percentage of assets in the BRAZIL asset category. Conversely, a high category value (1.0) may generally indicate a relatively high percentage of the unique portfolio's assets are allocated in that particular asset category. For example, portfolio number 1 of FIG. 3 is assigned a category value of 1.0 for the asset category CHINA, indicating unique portfolio number 1 has a relatively high percentage of assets in the CHINA asset category.

Next, with specific reference to FIG. 4, the category value assigned to each asset category of each unique portfolio may be used to cluster the unique portfolios into a plurality of portfolio clusters. More specifically, the unique portfolios of the portfolio knowledge base may be organized into clusters based on similarities between category values assigned to respective asset categories. Therefore, the unique portfolios within a single cluster will have similar category values assigned to similar asset categories, and as such, similar asset allocations in similar asset categories.

In an embodiment, clustering algorithms such as k-means clustering may be used to cluster the unique portfolios. For example, select a number of clusters K so that K is at least 5-10 times greater than the number of financial assets, and the number of portfolios in the database is at least 5-10 greater than K.

For example, the post-clusterization chart of FIG. 4 illustrates each of the ten unique portfolios depicted in FIG. 3 after being organized into five clusters. Each of the five clusters is populated with unique portfolios having substantially similar asset allocations in the same asset categories. For example, cluster 1 includes unique portfolios 5 and 9, both of which have relatively high asset allocation in BRAZIL, TECHNOLOGY, 1,000-10,000 employees, and 10-100 M$ revenue. Portfolios 5 and 9 are categorized in a single cluster because they have substantially similar asset allocations in similar asset categories. It should be noted that portfolios categorized in a single cluster may not have similar assets, but rather contain asset allocations in similar asset categories.

It should be noted that the number of portfolios and asset categories depicted in the figures are limited for illustration purposes only. Furthermore, the range and scale of category values is limited for illustration purposes only and a different scale with different graduations may be used for improved granularity and/or accuracy.

With continued reference to FIG. 2, the portfolio generation program 116 may calculate or predict financial metrics for each asset within the portfolio knowledge base (step 206). More specifically, known predictive analytic techniques are used to compute, for example, a return distribution for each individual asset, from which the returns of individual portfolio clusters may be predicted. Predicting the returns of an individual portfolio cluster may further include estimating average asset composition for each individual portfolio cluster. Finally, other financial metrics, such as, for example, risk and liquidity may similarly be computed for each portfolio cluster.

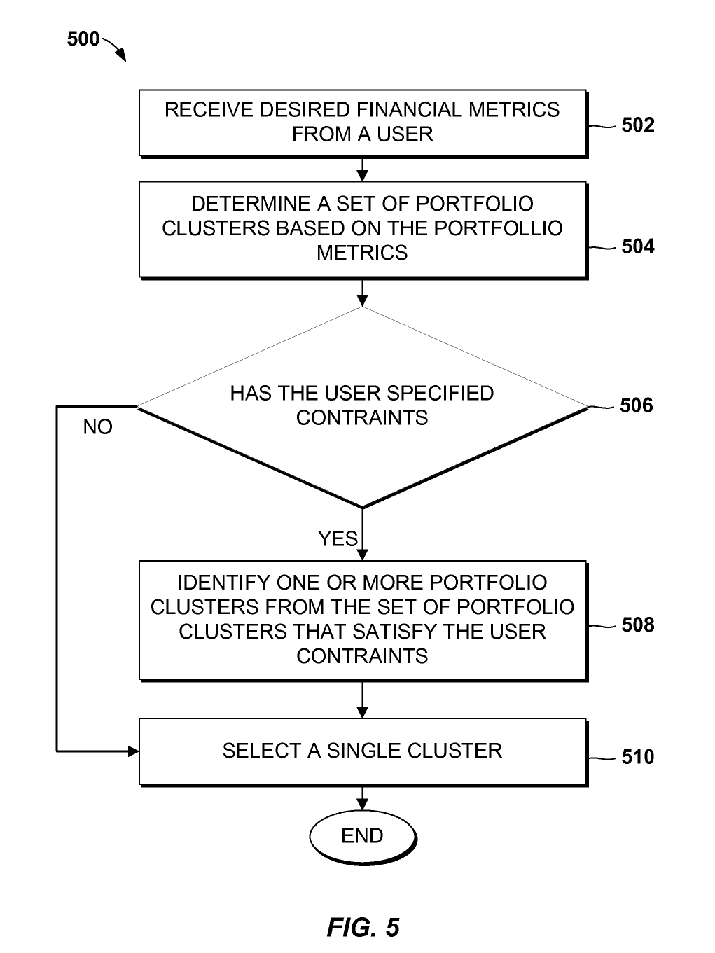

Referring now to FIG. 5, and with continued reference to FIG. 2, a flowchart 500 depicting operational steps of identifying one or more target portfolio clusters from the plurality of portfolio clusters in the portfolio knowledge base (step 208), is shown in accordance with an embodiment of the present invention. First, the portfolio generation program 116 receives the desired financial metrics from a user (step 502).

In an embodiment, the portfolio generation program 116 may receive the financial metrics from a sample portfolio provided by the user. Alternatively, the portfolio generation program 116 may receive the financial metrics as user inputs. In an embodiment, more specifically, an owner or user may input the financial metrics into the client computer 102, and the portfolio generation program 116 running on the server computer 104 may receive the same from the client computer 102 via the communication network 106.

For example, the financial metrics may include but are not limited to, expected return and value-at-risk (VaR). Next, a set of portfolio clusters satisfying the desired financial metrics are selected by comparing and matching the sample portfolio and/or user provided metrics to the portfolio clusters in the portfolio knowledge base (step 504). The set of portfolio clusters may include one or more portfolio clusters that satisfy the preferred financial metrics of the user.

In an embodiment, the portfolio generation program 116 may use mathematical optimization or multi-objective optimization to compute the pareto optimal set of financial portfolio clusters or efficient frontier set of portfolio clusters based on the desired financial metrics. In the present embodiment, the efficient frontier may be a set of optimal portfolios that offers the highest expected return for a defined level of risk or the lowest risk for a given level of expected return in which the financial metrics define the risk and/or expected return. In general, portfolios that lie below the efficient frontier are sub-optimal, because they do not provide enough return for the level of risk. Additionally, portfolios that lie to the right of the efficient frontier are also sub-optimal, because they have a higher level of risk for the defined rate of return.

After the set of portfolio clusters is chosen, any additional investment preferences may be considered and the set of portfolio clusters may be further narrowed, if at all (step 506). Optionally, additional investment preferences or constraints regarding specific assets, asset categories, etc. may also be provided by the user. For example, a user may prefer that predicted risk or predicted return should be below or above a certain threshold, respectively. For example, the user may also prefer that the target portfolio should belong to the same cluster as the user's current portfolio or a sample portfolio, or that some of the category values of a particular asset category for the target portfolio cluster must be within a certain range, for example 50-60% of assets in Asia. In other words, the set of portfolio clusters may shrink or be reduced after taking into consideration any additional investment preferences. If the user provides additional investment preferences, a sub-set of portfolio clusters satisfying the additional investment preferences may be selected from the set of portfolio clusters (step 508), from which one or more target portfolio clusters may be selected (step 510).

If the user does not provide any additional investment preferences, one or more target portfolio clusters may be selected from the set of portfolio clusters (step 510). The target portfolio cluster(s) may preferably have similar asset allocations in similar asset categories as the sample portfolio provided by the user. Furthermore, the target portfolio cluster(s) may preferably have similar investment constraints or financial metrics as the sample portfolio provided by the user. In an embodiment, for example, the portfolio generation program 116 may provide the client computer 102, and as such the user, with the set of portfolio clusters, or a subset of portfolio clusters, from which the user may choose a target portfolio cluster. It should be noted that the target portfolio cluster(s) may either be identified and chosen by the portfolio generation program 116 or identified by the portfolio generation program 116 and chosen by the user.

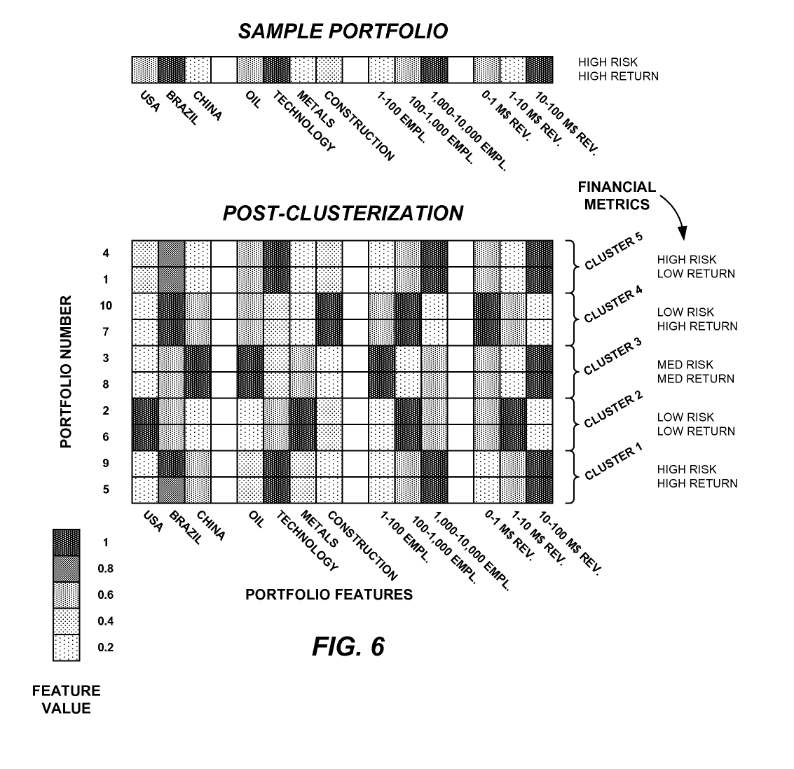

Referring now to FIG. 6, for example, identification of the target portfolio cluster based on a sample portfolio provided by the user is illustrated. A sample portfolio provided by the user is depicted directly above the post-clusterization chart. As illustrated, the assets of the sample portfolio are categorized and category values are assigned to each asset category, like described above with reference to FIG. 3. It should be noted that featurization of the sample portfolio should be carried out in a similar manner using a similar scale as featurization of the unique portfolios in the portfolio knowledge base to ensure efficiency and accuracy. Doing so, facilitates subsequent comparison between the sample portfolio and the portfolio clusters of the portfolio knowledge base.

In the present example, the sample portfolio is most similar to cluster 1 and cluster 5 with respect to asset allocation as determined by comparing respective category values. Next, with respect to the financial metrics, the sample portfolio is most similar to cluster 1, both of which are classified as high risk high return. Therefore, cluster 1 may be chosen or selected as the target portfolio cluster due to it close match to the sample portfolio and satisfaction of the user provided financial metrics. Cluster 5 is classified as being high risk low return, and therefore, cluster 5 in the present example, would not likely be considered for the target portfolio cluster due to the mismatch between the financial metrics, specifically the low return. It should be noted that if the portfolio generation program 116 identifies more than one target cluster, it may instruct the user to select a single target portfolio cluster.

With continued reference to FIG. 2, the portfolio generation program 116 may generate a creative list of novel portfolios within the boundaries of the target portfolio cluster (step 210). More specifically, various combinations of assets may be grouped into one or more novel portfolios which closely align with the asset allocation and financial metrics of the target portfolio cluster. Stated differently, the creative list of novel portfolios may include all the possible combinations of assets that produce any number portfolios that falls into the target portfolio cluster. There could be billions or more combinations and the creative list may be limited to a subset. In an embodiment, each novel portfolio in the list may be assigned a novelty score computed based on the concept of, for example, Bayesian surprise (Bayesian theory of surprise), where novelty is a property of an entire novel portfolio. Any of the novel portfolios having a novelty score below a certain threshold may further be eliminated from the list of novel portfolios. The surprise and other scores may be computed simultaneously while generating the combinations, which may be used to immediately discard individual novel portfolios with low scores or that rank low. In an embodiment, individual assets may optionally be excluded if their attributes or financial metrics deviate too far from the user defined financial objectives.

With continued reference to FIG. 2, the portfolio generation program 116 may select and recommend one or more novel portfolio(s) from the list of novel portfolios (step 212). More specifically, the recommended novel portfolios may preferably score high on the user-specified attributes, such as, for example, expected return and value-at-risk (VaR), in addition to satisfying any additional investment preferences and/or constraints. Selection of the “best” or most suitable novel portfolio may include the use of any known tool or software, such as, for example, known optimization models. In an embodiment, any known optimization model may be used to recommend one or more novel portfolios from the list of novel portfolios.

Referring now to FIG. 7, a block diagram of components of a computing device, such as the client computer 102 or the server computer 104, of the system 100 of FIG. 1, in accordance with an embodiment of the present invention is shown. It should be appreciated that FIG. 7 provides only an illustration of one implementation and does not imply any limitations with regard to the environments in which different embodiments may be implemented. Many modifications to the depicted environment may be made.

The computing device may include one or more processors 702, one or more computer-readable RAMs 704, one or more computer-readable ROMs 706, one or more computer readable storage media 708, device drivers 712, a read/write drive or interface 714, a network adapter or interface 716, all interconnected over a communications fabric 718. The communications fabric 718 may be implemented with any architecture designed for passing data and/or control information between processors (such as microprocessors, communications and network processors, etc.), system memory, peripheral devices, and any other hardware components within a system.

One or more operating systems 710, and one or more application programs 711, for example, the portfolio generation program 116, are stored on the one or more of the computer readable storage media 708 for execution by one or more of the processors 702 via one or more of the respective RAMs 704 (which typically include cache memory). In the illustrated embodiment, each of the computer readable storage media 708 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

The computing device may also include the R/W drive or interface 714 to read from and write to one or more portable computer readable storage media 726. Application programs 711 on the computing device may be stored on one or more of the portable computer readable storage media 726, read via the respective R/W drive or interface 714 and loaded into the respective computer readable storage media 708.

The computing device may also include the network adapter or interface 716, such as a TCP/IP adapter card or wireless communication adapter (such as a 4G wireless communication adapter using OFDMA technology). Application programs 711 on the computing device may be downloaded to the computing device from an external computer or external storage device via a network (for example, the Internet, a local area network or other wide area network or wireless network) and network adapter or interface 716. From the network adapter or interface 716, the programs may be loaded onto computer readable storage media 708. The network may comprise copper wires, optical fibers, wireless transmission, routers, firewalls, switches, gateway computers and/or edge servers.

The computing device may also include a display screen 720, a keyboard or keypad 722, and a computer mouse or touchpad 724. The device drivers 712 interface to the display screen 720 for imaging, to the keyboard or keypad 722, to the computer mouse or touchpad 724, and/or to the display screen 720 for pressure sensing of alphanumeric character entry and user selections. The device drivers 712, R/W drive or interface 714 and network adapter or interface 716 may include hardware and software (stored on computer readable storage media 708 and/or ROM 706).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Based on the foregoing, a computer system, method, and computer program product have been disclosed. However, numerous modifications and substitutions can be made without deviating from the scope of the present invention. Therefore, the present invention has been disclosed by way of example and not limitation.

1. A method for generating financial portfolios, the method comprising:
categorizing, by a computer, financial assets in a database of financial portfolios into asset categories based on their characteristics;
clustering, by the computer, the financial portfolios of the database into a plurality of portfolio clusters based on the asset categories, each portfolio cluster comprises financial portfolios having similar asset allocations in similar asset categories;
identifying, by the computer, a target portfolio cluster from the plurality of portfolio clusters based on pre-defined financial metrics; and
generating, by the computer, novel combinations of assets within the boundaries of the target portfolio cluster, the novel combinations of assets have similar asset allocations in similar asset categories and similar financial metrics as the target portfolio cluster.

2. The method of claim 1, further comprising:
identifying, by the computer, a discrete set of portfolio clusters from the plurality of portfolio clusters by comparing financial metrics of each portfolio cluster with pre-defined financial metrics using multi-objective optimization to compute a pareto optimal set.

3. The method of claim 1, further comprising:
removing, by the computer, one or more novel combinations of assets based on attributes of one or more individual assets within the novel combination of assets being removed.

4. The method of claim 1, further comprising:
calculating, by the computer, financial metrics for the assets in the portfolio database using predictive analytics; and
calculating, by the computer, financial metrics for the plurality of portfolio clusters in the portfolio database using the financial metrics calculated for the assets.

5. The method of claim 1, further comprising:
identifying, by the computer, one of the novel combinations of assets based on a novelty score computed using Bayesian theory of surprise.

6. The method of claim 1, wherein identifying, by the computer, the target portfolio cluster from the plurality of portfolio clusters based on pre-defined financial metrics comprises:
receiving the pre-defined financial metrics;
calculating financial metrics for each portfolio cluster in the portfolio database using predictive analytics; and
identifying the target portfolio cluster that has similar financial metrics as the pre-defined financial metrics.

7. The method of claim 1, wherein identifying, by the computer, the target portfolio cluster from the plurality of portfolio clusters based on pre-defined financial metrics comprises:
receiving the pre-defined financial metrics in the form of a sample financial portfolio;
calculating financial metrics for the sample portfolio;
calculating financial metrics for each portfolio cluster in the portfolio database using predictive analytics; and
identifying the target portfolio cluster that has similar financial metrics as the sample financial portfolio.

8. The method of claim 1, further comprising:
creating the database of financial portfolios comprising:
compiling, by the computer, financial portfolios from at least two or more different sources into a portfolio database; and
splitting the financial portfolios into unique portfolios having a consistent asset allocation over time.

9. A computer program product for generating financial portfolios, the computer program product comprising:
one or more computer-readable storage media and program instructions stored on the one or more computer-readable storage media, the program instructions comprising:
program instructions to categorize financial assets in a database of financial portfolios into asset categories based on their characteristics;
program instructions to cluster the financial portfolios of the database into a plurality of portfolio clusters based on the asset categories, each portfolio cluster comprises financial portfolios having similar asset allocations in similar asset categories;
program instructions to identify a target portfolio cluster from the plurality of portfolio clusters based on pre-defined financial metrics; and
program instructions to generate novel combinations of assets within the boundaries of the target portfolio cluster, the novel combinations of assets have similar asset allocations in similar asset categories and similar financial metrics as the target portfolio cluster.

10. The computer program product of claim 9, further comprising:
program instructions to identify a discrete set of portfolio clusters from the plurality of portfolio clusters by comparing financial metrics of each portfolio cluster with pre-defined financial metrics using multi-objective optimization to compute a pareto optimal set.

11. The computer program product of claim 9, further comprising:
program instructions to remove one or more novel combinations of assets based on attributes of one or more individual assets within the novel combination of assets being removed.

12. The computer program product of claim 9, further comprising:
program instructions to identify one of the novel combinations of assets based on a novelty score computed using Bayesian theory of surprise.

13. The computer program product of claim 9, wherein identifying, by the computer, the target portfolio cluster from the plurality of portfolio clusters based on pre-defined financial metrics comprises:
program instructions to receive the pre-defined financial metrics;
program instructions to calculate financial metrics for each portfolio cluster in the portfolio database using predictive analytics; and
program instructions to identify the target portfolio cluster that has similar financial metrics as the pre-defined financial metrics.

14. The computer program product of claim 9, wherein identifying, by the computer, the target portfolio cluster from the plurality of portfolio clusters based on pre-defined financial metrics comprises:
program instructions to receive the pre-defined financial metrics in the form of a sample financial portfolio;
program instructions to calculate financial metrics for the sample portfolio;
program instructions to calculate financial metrics for each portfolio cluster in the portfolio database using predictive analytics; and
program instructions to identify the target portfolio cluster that has similar financial metrics as the sample financial portfolio.

15. A computer system for generating financial portfolios, the computer system comprising:
one or more computer processors, one or more computer-readable storage media, and program instructions stored on one or more of the computer-readable storage media for execution by at least one of the one or more processors, the program instructions comprising:
program instructions to categorize financial assets in a database of financial portfolios into asset categories based on their characteristics;
program instructions to cluster the financial portfolios of the database into a plurality of portfolio clusters based on the asset categories, each portfolio cluster comprises financial portfolios having similar asset allocations in similar asset categories;
program instructions to identify a target portfolio cluster from the plurality of portfolio clusters based on pre-defined financial metrics; and
program instructions to generate novel combinations of assets within the boundaries of the target portfolio cluster, the novel combinations of assets have similar asset allocations in similar asset categories and similar financial metrics as the target portfolio cluster.

16. The system of claim 15, further comprising:
program instructions to identify a discrete set of portfolio clusters from the plurality of portfolio clusters by comparing financial metrics of each portfolio cluster with pre-defined financial metrics using multi-objective optimization to compute a pareto optimal set.

17. The system of claim 15, further comprising:
program instructions to remove one or more novel combinations of assets based on attributes of one or more individual assets within the novel combination of assets being removed.

18. The system of claim 15, further comprising:
program instructions to identify one of the novel combinations of assets based on a novelty score computed using Bayesian theory of surprise.

19. The system of claim 15, wherein identifying, by the computer, the target portfolio cluster from the plurality of portfolio clusters based on pre-defined financial metrics comprises:
program instructions to receive the pre-defined financial metrics;
program instructions to calculate financial metrics for each portfolio cluster in the portfolio database using predictive analytics; and
program instructions to identify the target portfolio cluster that has similar financial metrics as the pre-defined financial metrics.

20. The system of claim 15, wherein identifying, by the computer, the target portfolio cluster from the plurality of portfolio clusters based on pre-defined financial metrics comprises:
program instructions to receive the pre-defined financial metrics in the form of a sample financial portfolio;
program instructions to calculate financial metrics for the sample portfolio;
program instructions to calculate financial metrics for each portfolio cluster in the portfolio database using predictive analytics; and
program instructions to identify the target portfolio cluster that has similar financial metrics as the sample financial portfolio.
